(19) United States
(12) Patent Application Publication
(10) Pub. No.: US 2011/0055882 A1
(43) Pub. Date: Mar. 3, 2011

(54) VIDEO DELIVERY APPARATUS AND VIDEO DELIVERY METHOD

(76) Inventor: Yasuo OHYA, Tokyo (JP)

(21) Appl. No.: 12/852,771

(22) Filed: Aug. 9, 2010

(30) Foreign Application Priority Data
Sep. 2, 2009 (JP) P2009-202906

(51) Int. Cl. H04N 7/173

(52) U.S. Cl. 725/93

(57) ABSTRACT

In one embodiment, a video delivery apparatus includes a determination unit, a search unit, and a delivery control unit. The determination unit determines that there is a margin in a transmission band when a state in which a packet discard rate periodically received from a receiver is below the threshold value has continued over a preset period. The search unit searches for a replacement content with a bit rate higher than a bit rate of a currently delivered video content, when it is determined that there is a margin in the transmission band as a result of determination by the determination unit. The delivery control unit sends the replacement content in place of the currently delivered video content when the replacement content has been searched by the search unit.

### CROSS REFERENCE TO RELATED APPLICATION

This application is based upon and claims the benefit of priority from Japanese Patent Application No. 2009-202906, filed on Sep. 2, 2009; the entire contents of which are incorporated herein by reference.

### FIELD

Embodiments described herein relate generally to, for example, a video delivery apparatus and a video delivery method used in a VOD (Video On Demand) system and the like.

### BACKGROUND

The VOD (Video On Demand) system is a system which delivers a video content on demand from a viewer. To watch a movie, for example, the viewer selects a title of the movie on a VOD receiver (a personal computer or a television set connected to a dedicated device) connected to a network. As a result of this, a content of the movie is delivered from a video content delivery server to the VOD receiver, so that the viewer can view the desired movie even at home. Examples of the network include, for example, the Internet and CDN (Contents Delivery Network).

However, the band of such a network becomes unstable due to the influence of a change in the communication environment occurring on the network, and a sufficient band is not secured for the video content on the delivery side in many cases. In this case, the viewing performance degrades, such as deterioration of the image quality or the like.

Hence, in recent years, techniques of realizing viewing in accordance with the variation in the band of a line are disclosed. More specifically, the packet loss rate of the currently received streaming data is monitored on the reception side, and when the packet loss rata exceeds a threshold value, a quality level down request is transmitted to a streaming delivery server. The streaming delivery server which has received this request degrades the transfer quality level of data to thereby prevent sudden deterioration of the image quality.

Incidentally, degrading the transfer quality level of data due to the increase in the packet loss rate is switching only in one direction. Therefore, the viewer who can secure a sufficient transmission band can miss the opportunity to view with an image quality by making use of the transmission band.

### BRIEF DESCRIPTION OF THE DRAWINGS

FIG. 1 is a diagram showing the configuration of a video delivery system of an embodiment.

FIG. 2 is a flowchart showing the operation in a case in which the available band is decreased during viewing in the video delivery system.

FIG. 3 is a flowchart showing the operation in a case in which the available band is increased during viewing in the video delivery system.

FIG. 4 is a graph depicting the temporal change in bit rate of data transmitted from a video content delivery server.

### DETAILED DESCRIPTION

In one embodiment, a video delivery apparatus connected to a receiver via a network includes a video content storage unit, a monitoring unit, a determination unit, a search unit, and a delivery control unit. The video content storage unit stores a plurality of video contents created at different bit rates. The monitoring unit monitors a change in a state of a transmission band for the video content by comparing a packet discard rate periodically received from the receiver to a preset threshold value during delivery of a video content designated by the receiver. The determination unit determines that there is a margin in the transmission band when a state in which the packet discard rate is below the threshold value has continued over a preset period. The search unit searches for presence/absence of a replacement content with a bit rate higher than a bit rate of a currently delivered video content, from the video content storage unit when the determination unit determines that there is a margin in the transmission band. The delivery control unit delivers the replacement content to the receiver in place of the currently delivered video content when the replacement content has been searched by the search unit.

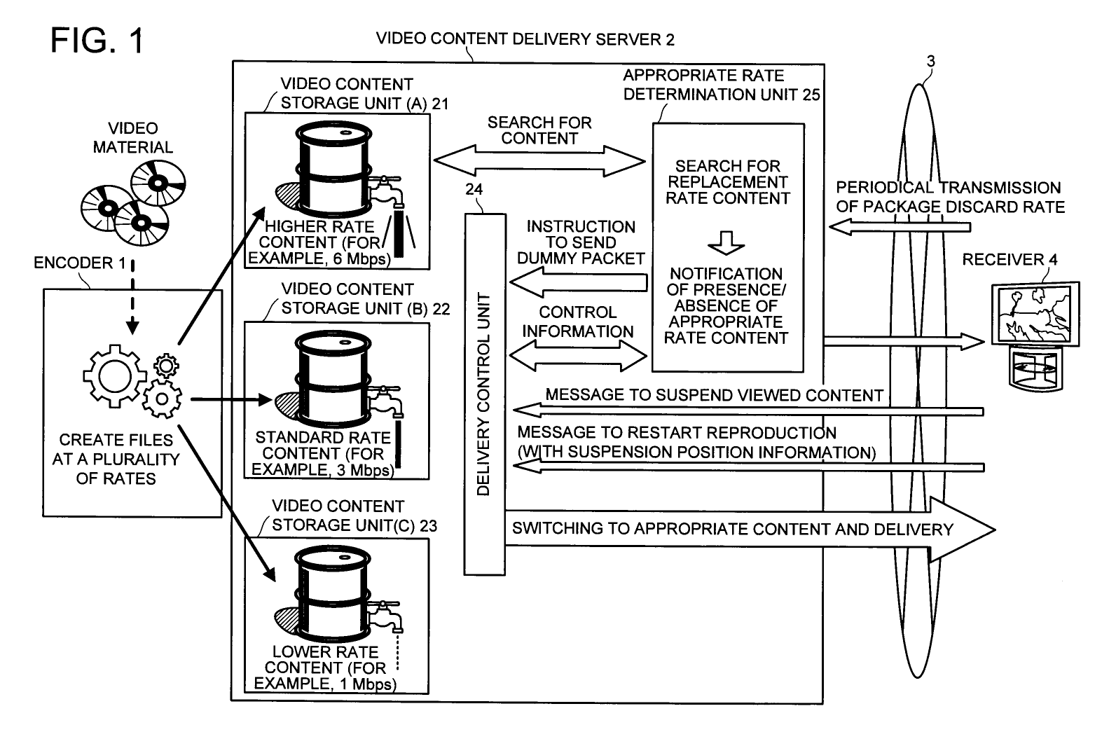

A video delivery system of an embodiment will be described in detail below with reference to the drawings. FIG. 1 is a diagram showing the configuration of the video delivery system.

As shown in FIG. 1, the video delivery system of this embodiment is configured such that an encoder 1 is connected to a video content delivery server 2 via a network such as a LAN, and the video content delivery server 2 is connected to a VOD receiver 4 (hereinafter referred to as a “receiver 4”) as a receiving terminal for viewing video via a network such as a WAN 3.

The encoder 1 creates a plurality of files of video contents with an identical content at different bit rates based on a video material, and stores the files in the video content delivery server 2.

The receiver 4 is, for example, a computer or a set-top box dedicated for this system. The receiver 4 has the following functions (1) to (4).

(1) A function of requesting a video content that is selected by a viewer from a list displayed on a screen, from the video content delivery server 2

(2) A function of receiving, over the network, the video content delivered on demand from the video content delivery server 2

(3) A function of detecting the packet loss (packet discard rate) of the packet of the received video content

(4) A function of periodically sending the detected packet loss (packet discard rate) to an appropriate rate determination unit 25 of the video content delivery server 2

The video content delivery server 2 is a computer including a hard disk, a CPU, a memory and so on. The video content delivery server 2 has video content storage units (A) 21, (B) 22, and (C) 23, a delivery control unit 24, and the appropriate rate determination unit 25.

The video content storage units (A) 21, (B) 22, and (C) 23 are embodied by the hard disk. In the video content storage unit (B) 22, a standard bit rate video content of a certain title is stored, for example, at a bit rate of 3 Mbps.

In the video content storage unit (A) 21, a higher bit rate video content of the same title as that stored in the video content storage unit (B) 22 is stored, for example, at a bit rate of 6 Mbps.

In the video content storage unit (C) 23, a lower bit rate video content of the same title as that stored in the video content storage unit (A) 21 is stored, for example, at a bit rate of 1 Mbps.

In short, in the video content storage units (A) 21, (B) 22, and (C) 23, the video contents with the same title at different bit rates are stored. A content containing the identical content at a different bit rate created for a certain content is referred to as a “replacement content.” Note that to cope with a smaller change in the bit rate, a plurality of replacement contents may be prepared.

The delivery control unit 24 and the appropriate rate determination unit 25 are embodied by the CPU reading programs stored in the hard disk into the memory and processing/executing the programs.

The appropriate rate determination unit 25 receives packet loss (packet discard rate) information which is periodically transmitted from the receiver 4. When the state in which the packet loss (packet discard rate) exceeds the preset threshold value has continued over the preset period, the appropriate rate determination unit 25 determines that the quality has deteriorated. When determining that the quality has deteriorated, the appropriate rate determination unit 25 searches for whether or not a content with a bit rate lower than the bit rate of the currently sent video content is stored in the video content storage unit (A) 21, (B) 22, (C) 23.

In other words, when the state in which the packet loss (packet discard rate) received from the receiver 4 exceeds the threshold value has continued for a fixed period, the appropriate rate determination unit 25 checks whether or not a video content with an adequate bit rate is stored in the video content storage unit (A) 21, (B) 22, (C) 23.

When determining that the video content with a bit rate lower than that of the current vide content is adequate, the appropriate rate determination unit 25 sends a message of the determination to the receiver 4.

When determining that a video content with a bit rate higher than that of the current video content can be applied, the appropriate rate determination unit 25 sends a dummy packet in parallel with the current video content. This is to collect the packet loss (packet discard rate) information at the bit rate equal to that of the video content with a higher rate.

When determining that a video content with a bit rate higher than that of the current video content is adequate, the appropriate rate determination unit 25 sends a message of the determination to the receiver 4.

In short, the appropriate rate determination unit 25 has functions as the monitoring unit, the determination unit, and the search unit. The monitoring unit monitors the change in the state of the transmission band for the video content by comparing the packet discard rate periodically received from the receiver 4 to the preset threshold value during the delivery of the video content designated from the receiver 4.

When the state in which the packet discard rate is below the threshold value has continued over the preset period, the appropriate rate determination unit 25 determines, as the determination unit, that there is a margin in the transmission band. As a result of the determination, when it is determined that there is a margin in the transmission band, the appropriate rate determination unit 25 searches, as the search unit, for presence/absence of a replacement content with a bit rate higher than that of the currently delivered video content, from the video content storage unit (A) 21, (B) 22, (C) 23.

As the result of the search by the search unit, when a replacement content is searched (when a replacement content exists) in any of the video content storage units (A) 21, (B) 22, and (C) 23, the delivery control unit 24 delivers the replacement content to the receiver 4 in place of the currently delivered video content.

The delivery control unit 24 has functions as a test transmission unit and a changing unit. The test transmission unit adds to the current video content a dummy packet for a bit rate corresponding to the difference in bit rate between the replacement content and the currently delivered video content, and test transmits the video content with the added dummy packet.

When the determination result by the determination unit has not changed during the test transmission of the video content with the added dummy packet by the test transmission unit, the changing unit sends the replacement content to the receiver 4 in place of the currently delivered video content.

The delivery control unit 24 controls the delivery of the video content when reproduction of the video content after the receiver 4 suspends viewing. More specifically, when a video content with amore adequate bit rate than that before the suspension exists, the delivery control unit 24 reproduces the video content with a new bit rate from a position of the suspension (switching of the video content).

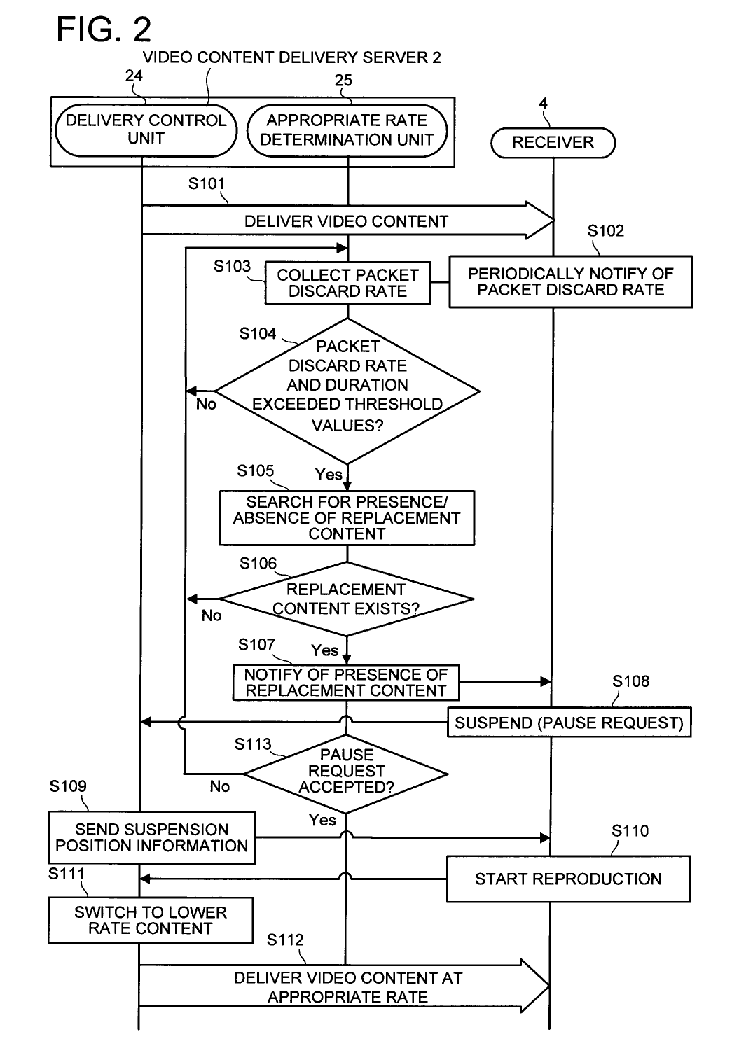

Hereinafter, the operation of the video delivery system will be described. The operation of the video delivery system in a case in which the available band is decreased during viewing of a video content will be described first with reference to the flowchart in FIG. 2.

When the viewer starts up the receiver 4 to view, for example, a movie, the receiver 4 accesses the video content delivery server 2 in a predetermined procedure. Then, a picture of the title list of movies is delivered from the video content delivery server 2 and displayed on the screen of the receiver 4.

When the viewer selects the title of a desired movie and performs a decision operation here, the request is sent to the video content delivery server 2. In the video content delivery server 2, the delivery control unit 24 reads a corresponding video content and starts streaming delivery of the video content (Step S101 in FIG. 2).

In this event, the delivery control unit 24 reads a video content with 3 Mbps that is the bit rate of default setting from the video content storage unit (B) 22 for reproduction of the movie of the selected title for the first time. Note that the content with a bit rate suitable for the band of the line of the viewer may be selected and read.

During delivery of the video content, the receiver 4 periodically transmits the packet discard rate of the received video content as the packet loss information to the video content delivery server 2 (Step S102).

In the video content delivery server 2, the appropriate rate determination unit 25 collects the packet loss (packet discard rate) information received from the receiver 4 (Step S103). For the collection of the packet discard rate, for example, RTCP protocol is used.

When the state in which the packet discard rate exceeds the preset threshold value has not continued over the preset period (No at Step S104), the appropriate rate determination unit 25 does not determine that the quality has deteriorated. In this case, the appropriate rate determination unit 25 returns to the processing at Step S103 and continues the collection of the packet discard rate.

On the other hand, when the state in which the packet discard rate exceeds the preset threshold value has continued over the preset period (Yes at Step S104), the appropriate rate determination unit 25 determines that the quality has deteriorated. In this case, the appropriate rate determination unit 25 searches for whether or not a content (replacement content) with a bit rate lower than the bit rate of the currently sent video content exists in the video content storage unit (A) 21, (B) 22, (C) 23 (Step S105).

As a result of the search, when no replacement content exists (No at Step S106), the appropriate rate determination unit 25 returns to the processing at Step S103 and continues the collection of the packet discard rate.

On the other hand, as the result of the search, when a replacement content exists (Yes at Step S106), the appropriate rate determination unit 25 sends a message that there is a replacement content with a lower bit rate to the receiver 4 to thereby notify the receiver 4 of the presence of the replacement content (Step S107).

Upon receipt of the message that there is a replacement content with a lower bit rate from the video content delivery server 2, the receiver 4 suspends the currently reproduced video content in order to switch the video of the video content which has been received till then to the video of the replacement content. Then, the receiver 4 transmits a suspension command (PAUSE request) to the video content delivery server 2 (Step S108).

Here, the receiver 4 does not transmit the suspension command (PAUSE request) to the video content delivery server 2 when the receiver 4 does not have the function of processing the notification of the presence of the replacement content or when the receiver 4 continues viewing without suspending the video content.

In the video content delivery server 2, when the suspension command (PAUSE request) has not been accepted from the receiver 4 in a fixed period (No at Step S113), the appropriate rate determination unit 25 returns to the processing at Step S103 and continues the collection of the packet discard rate. Thereby, the normal reproduction is continued.

In the video content delivery server 2, the delivery control unit 24 inserts suspension position information (Renge:ntp=nnn.m) into a response message to the received suspension command and transmits the resulting response message to the receiver 4 (Step S109).

Upon receipt of the response message, the receiver 4 restarts the reproduction of the video content, and inserts the received suspension position information (Renge:ntp=nnn.m) into a reproduction command and transmits the resulting reproduction command to the delivery control unit 24 of the video content delivery server 2 (Step S110).

In the video content delivery server 2, the delivery control unit 24 is monitoring a series of operations of the notification of the replacement content, the suspension, and the reproduction. Upon receipt of the reproduction command, the delivery control unit 24 switches the read-target storage unit from the video content storage unit (B) 22 for the bit rate to which the delivery control unit 24 has been previously connected, to the video content storage unit (C) 23 storing the video content with a lower bit rate, from the suspension position information in the reproduction command (Step S111). In other words, the video content delivery server 2 reads the applicable video content from the video content storage unit (C) 23 and starts delivery of the video content with a lower bit rate (the video content with an appropriate rate) (Step S112).

In the above-described processing, the receiver 4 automatically (continuously) executes suspension and reproduction in response to the notification of the replacement content in the transmission/reception of the command with the server. Alternatively, the receiver 4 may display the screen urging the viewer to switch the video which the viewer is viewing, in response to the notification of the replacement content to thereby switch the video by a switching operation of the viewer.

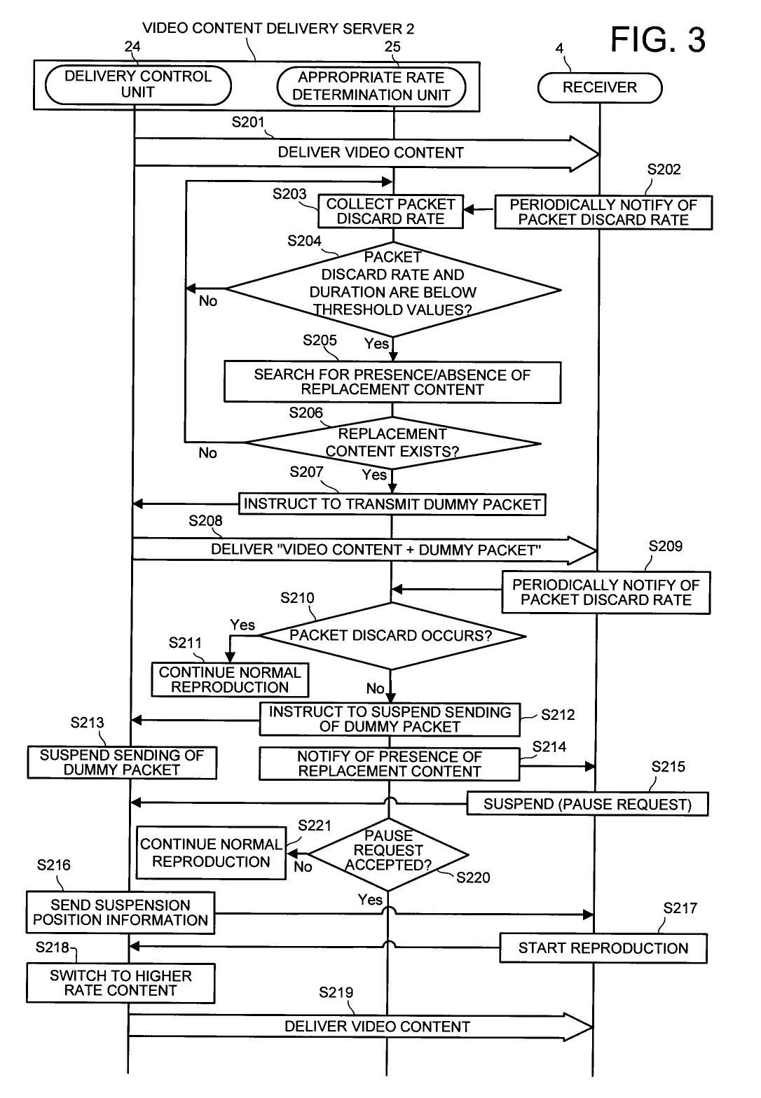

Next, the operation of the video delivery system in a case in which the available band is increased during viewing will be described with reference to the flowchart in FIG. 3.

In this case, it is assumed that streaming delivery of the video content of the title of the desired movie selected by the viewer is being performed from the video content delivery server 2 (Step S201 in FIG. 3).

During the delivery of the video content, the receiver 4 periodically transmits the packet discard rate of the received video content as the packet loss information to the video content delivery server 2 (Step S202).

In the video content delivery server 2, the appropriate rate determination unit 25 collects the packet loss (packet discard rate) information received from the receiver 4 (Step S203). For the collection of the packet discard rate, for example, RTCP protocol or the like is used.

When the state in which the packet discard rate is below the preset threshold value has not continued over the preset period (No at Step S204), the appropriate rate determination unit 25 does not determine that the quality has improved. In this case, the appropriate rate determination unit 25 returns to the processing at Step S203 and continues the collection of the packet discard rate.

On the other hand, when the state in which the packet discard rate is below the preset threshold value has continued over the preset period (Yes at Step S204), the appropriate rate determination unit 25 determines that the quality has improved, that is, there is a margin in the transmission band. In this case, the appropriate rate determination unit 25 searches for whether or not a content (replacement content) with a bit rate higher than the bit rate of the currently sent video content exists in the video content storage unit (A) 21, (B) 22, (C) 23 (Step S205).

As a result of the search, when no replacement content exists (No at Step S206), the appropriate rate determination unit 25 returns to the processing at Step S203 and continues the collection of the packet discard rate.

On the other hand, as the result of the search, when a replacement content exists (Yes at Step S206), the appropriate rate determination unit 25 instructs the delivery control unit 24 to transmit to the receiver 4 a dummy packet for a bit rate corresponding to the difference in bit rate between the replacement content with a higher bit rate and the currently sent video content (Step S207).

The delivery control unit 24 adds the dummy packet to the current video content, and sends the content with the increased rate to the designated receiver 4. In this event, a packet that is adjusted in data size using a stuffing byte or the like is used as the dummy packet.

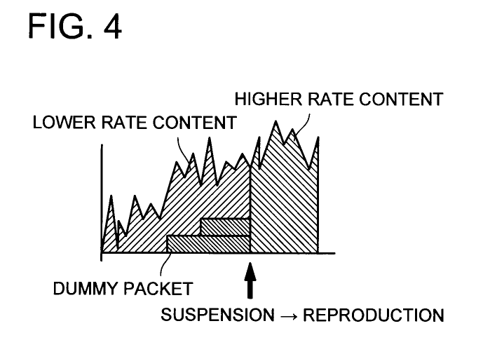

However, when the apparent bit rate is sharply increased using the dummy packet, the packet discard rate may deteriorate at once. Therefore, the delivery control unit 24 conducts a control during the test transmission in such a manner to gradually increase the data size of the dummy packet by a predetermined amount starting form a small size to fill the difference between the current video content and the replacement content. FIG. 4 is a graph depicting the temporal change in the bit rate in this event.

During the time when the data size is gradually increased to reach the same rate as that of the higher rate content, the appropriate rate determination unit 25 collects the packet discard rate sent from the receiver 4 and determines whether or not the packet discard rate exceeds the preset threshold value (Step S210). The threshold value in this case is the threshold value indicating the upper limit of the packet discard rate to determine whether or not the discard rate has deteriorated.

When the packet discard rate has exceeded the threshold value by the time when the data size reaches the same rate as that of the higher rate content (Yes at Step S210), the appropriate rate determination unit 25 determines that the band sufficient to deliver the higher rate content cannot be secured. In this case, the appropriate rate determination unit 25 stops the delivery of the content with the added dummy packet, returns to the state of delivery only of the original video content, and continues the collection of the packet discard rate. Thereby, the normal reproduction is continued (Step S211).

On the other hand, when the packet discard rate has not exceeded the threshold value at the same rate as that of the higher rate content (No at Step S210), that is, when the determination result has not changed during the test transmission of the video content with the added dummy packet, the appropriate rate determination unit 25 determines that the band capable of dealing with the delivery of the higher rate content has been secured. In this case, the appropriate rate determination unit 25 instructs the delivery control unit 24 to suspend the sending of the content with the added dummy packet (Step S212).

Following this instruction, the delivery control unit 24 suspends the sending of the content with the added dummy packet (Step S213).

Further, after the instruction to suspend the sending of the content with the added dummy packet, the appropriate rate determination unit 25 sends a message that there is a replacement content with a bit rate higher than that of the current video content to the receiver 4 to thereby notify the receiver 4 of the presence of the replacement content (Step S214).

Upon receipt of the message that there is a replacement content with a higher bit rate from the video content delivery server 2, the receiver 4 suspends the currently reproduced video content in order to switch the video of the video content which has been received till then to the video of the replacement content. Then, the receiver 4 transmits a suspension command (PAUSE request) to the video content delivery server 2 (Step S215).

Here, the receiver 4 does not transmit the suspension command (PAUSE request) to the video content delivery server 2 when the receiver 4 does not have the function of processing the notification of the presence of the replacement content or when the receiver 4 continues viewing without suspending the video content.

In the video content delivery server 2, when the suspension command (PAUSE request) has not been accepted from the receiver 4 in a fixed period (No at Step S220), the appropriate rate determination unit 25 returns to the processing at Step S203 and continues the collection of the packet discard rate. Thereby, the normal reproduction is continued (Step S221).

In the video content delivery server 2, the delivery control unit 24 inserts suspension position information (Renge:ntp=nnn.m) into a response message to the received suspension command and transmits the resulting response message to the receiver 4 (Step S216).

Upon receipt of the response message, the receiver 4 restarts the reproduction of the video content, and inserts the received suspension position information (Renge:ntp=nnn.m) into a reproduction command and transmits the resulting reproduction command to the delivery control unit 24 of the video content delivery server 2 (Step S217).

In the video content delivery server 2, the delivery control unit 24 is monitoring a series of operations of the notification of the replacement content, the suspension, and the reproduction. Upon receipt of the reproduction command, the delivery control unit 24 switches the read-target storage unit from the video content storage unit (B) 22 for the bit rate to which the delivery control unit 24 has been previously connected, to the video content storage unit (A) 21 storing the video content with a higher bit rate, from the suspension position information in the reproduction command (Step S218). In other words, the video content delivery server 2 reads the applicable video content from the video content storage unit (A) 21 and starts delivery of the video content with a higher bit rate (the video content with an appropriate rate) (Step S219).

Also in this case, the receiver 4 automatically (continuously) executes suspension and reproduction in response to the notification of the replacement content in the transmission/reception of the command with the server. Alternatively, the receiver 4 may display the screen urging the viewer to switch the video which the viewer is viewing in response to the notification of the replacement content to thereby switch the video by a switching operation of the viewer.

As described above, the video delivery system of this embodiment monitors the state of the transmission band at all times by comparing the packet discard rate periodically received from the receiver 4 to the preset threshold value, and sends a video content with a bit rate suitable for the state of the transmission band. As the result of this, the viewer can view the video content at an optimal bit rate suitable for the band which can be secured on the reception side.

Especially when the state in which the packet discard rate is below the threshold value has continued over the preset period, it is determined that there is a margin in the transmission band. In this case, if there is a replacement content with a bit rate higher than that of the currently sent video content, a dummy packet for the bit rate corresponding to the difference in bit rate between the replacement content and the currently delivered video content is added to the currently delivered video content, and the currently delivered video content with the added dummy packet is test transmitted (test for the transmission state of a video content with a higher rate). If the result of the test is excellent, the replacement content with the higher rate is delivered. Consequently, the viewing opportunity of the video content with an image quality by making use of the band can be stably provided especially to the viewer who can secure a sufficient band.

While certain embodiments have been described, these embodiments have been presented by way of example only, and are Not intended to limit the scope of the inventions. Indeed, the Novel methods and apparatuses described herein may be embodied in a variety of other forms; furthermore, various omissions, substitutions and changes in the form of the methods and apparatuses described herein may be made without departing from the spirit of the inventions. The accompanying claims and their equivalents are intended to cover such forms or modifications as would fall within the scope and spirit of the inventions.

For example, components can be realized by programs installed in a storage such as a hard disk drive of a computer. Further, the above-described programs may be realized by being stored in computer-readable electronic media and read from the electronic media into a computer which realizes the functions of components. The electronic media include, for example, a recording medium such as a CD-ROM or the like, flash memory, removable media and the like.

Further, the components may be realized by being dispersedly stored in different computers which are connected via a network, and communicated among the computers in which the components function.

What is claimed is:

1. A video delivery apparatus connected to a receiver via a network, the apparatus, comprising:
a video content storage unit configured to store a plurality of video contents created at different bit rates;
a monitoring unit configured to monitor a change in a state of a transmission band for the video content by comparing a packet discard rate periodically received from the receiver to a preset threshold value during delivery of a video content designated by the receiver;
a determination unit configured to determine that there is a margin in the transmission band when a state in which the packet discard rate is below the threshold value has continued over a preset period;
a search unit configured to search for presence/absence of a replacement content with a bit rate higher than a bit rate of a currently delivered video content, from the video content storage unit when the determination unit determines that there is a margin in the transmission band; and
a delivery control unit configured to deliver the replacement content to the receiver in place of the currently delivered video content when the replacement content has been searched by the search unit.

2. The video delivery apparatus according to claim 1,
wherein the delivery control unit comprises:
a transmission unit configured to add a dummy packet for a bit rate corresponding to a difference in bit rate between the replacement content and the currently delivered video content, to the current video content and transmit the current video content with the added dummy packet, when the replacement content exists in the video content storage unit as a result of the search by the search unit; and
a changing unit configured to send the replacement content to the receiver in place of the currently delivered video content, when a result of determination by the determination unit has not changed during transmission of the video content with the added dummy packet by the transmission unit.

3. The video delivery apparatus according to claim 2,
wherein the transmission unit conducts a control during the transmission to gradually increase a data size of the dummy packet to fill the difference from the replacement content.

4. The video delivery apparatus according to claim 1,
wherein the delivery control unit transmits to the receiver a message notifying that there is a replacement content for the currently delivered video content, and delivers the replacement content to reproduce the replacement content from a position where a suspension operation has been performed in the receiver.

5. A video delivery method in a video delivery apparatus connected to a receiver via a network, the method, comprising:
storing a plurality of video contents created at different bit rates in a video content storage unit;
monitoring a change in a state of a transmission band for the video content by comparing a packet discard rate periodically received from the receiver to a preset threshold value during delivery of a video content designated by the receiver;
determining that there is a margin in the transmission band when a state in which the packet discard rate is below the threshold value has continued over a preset period;
searching for presence/absence of a replacement content with a bit rate higher than a bit rate of a currently delivered video content, from the video content storage unit when, as a result of determination, it is determined that there is a margin in the transmission band; and
delivering the replacement content to the receiver in place of the currently delivered video content when, as a result of search, the replacement content has been searched.

6. The video delivery method according to claim 5,
wherein the delivering step comprises:
adding a dummy packet for a bit rate corresponding to a difference in bit rate between the replacement content and the currently delivered video content, to the current video content and transmitting the current video content with the added dummy packet, when the replacement content exists in the video content storage unit as a result of the search; and
sending the replacement content to the receiver in place of the currently delivered video content, when a result of the determination has not changed during transmission of the video content with the added dummy packet.

7. The video delivery method according to claim 6,
wherein in the transmitting step, a control is conducted to gradually increase a data size of the dummy packet to fill the difference from the replacement content.

8. The video delivery method according to claim 5,
wherein in the delivering step, a message notifying that there is a replacement content for the currently delivered video content is transmitted to the receiver, and the replacement content is delivered to be reproduced from a position where a suspension operation has been performed in the receiver.
